(19) United States
(12) Patent Application Publication
(10) Pub. No.: US 2018/0320747 A1
(43) Pub. Date: Nov. 8, 2018

(54) Springs with Dynamically Variable Stiffness and Actuation Capability

(71) Applicant: Philip BOGRASH, Ashdod (IL)

(72) Inventor: Philip BOGRASH, Ashdod (IL)

(21) Appl. No.: 15/773,716

(22) PCT Filed: Nov. 3, 2016
(86) PCT No.: PCT/IL16/51195

§ 371 Date: May 18, 2018

Related U.S. Application Data
(60) Provisional application No. 62/250,717, filed on Nov. 4, 2015.

(51) Int. Cl. F16F 1/04; F16F 1/22; F16F 9/10; F16F 9/44

(52) U.S. Cl. CPC F16F 1/041; F16F 1/22; F16F 2224/0258; F16F 9/44; F16F 9/106

(57) ABSTRACT

Springs of different types are provided with the ability to dynamically change stiffness. A number of embodiments feature hollow tubing wherein stiffness change is accomplished due to the pressure change inside the tubing which affects the stresses in tubing walls. In other embodiments inside pressure change causes variability in tubing's cross-section shape and size leading to large changes in stiffness. A number of embodiments feature spring coil diameter variability achieved by a variety of means and resulting in highly substantial changes in stiffness and for some embodiments spring length variability thus providing them with actuation capability in addition to stiffness variability.

### RELATIONSHIP TO OTHER APPLICATIONS

The present patent application is related pursuant to the concept of the unity of an invention to U.S. provisional patent applications 62/250,717 and 62/271,728 and claims benefit of the filing date of 62/250,717 provisional application

### 1. FIELD OF THE INVENTION

This invention relates to springs of various functions and types provided with the ability of changing their stiffness dynamically in real time or by manual adjustment and also optionally having the actuation capability.

### 2. DESCRIPTION OF THE PRIOR ART

There is a number of types of springs existing today which serve different functions, most common of them were invented several centuries ago and changed little since then. Most springs in normal operation change the force that they produce, in reaction to being either compressed or extended, linearly in proportion to the extent of their deformation and the Spring Rate which is alternatively known as the “Spring Constant”. The U.S. Pat. No. 8,448,962 presents an example of a helical spring which features restraining elements applied to the spring to immobilize a number of coils in it. Thus the shortened active part of the spring is rendered stiffer. That system also features a motor with a controller to move said restraining elements. That system is rather complicated mechanically and that unavoidably substantially increases its cost and decreases reliability, it limits the amount of movement that the remaining active part of the spring can do and therefore the range of stiffness variability is limited as the spring has to have movement. It certainly cannot change the spring stiffness dynamically or in real time. Finally this approach is only applicable to the helical springs and cannot be used for the springs of all the other types. There are other patents trying to develop this principle of limiting and varying the number of active coils in a helical spring while immobilizing the rest of them, but all those designs suffer from the same shortcomings, limitations and deficiencies.

Another approach for varying the stiffness is well known in the art for a very long time; it comprises a disk pressing on the end coils which are closed and ground to a flat plane. The spring is pre-compressed and thus is made stiffer. All the shortcomings and limitations described for the former design apply to the latter. The application PCT/IB2010/054846 describes a combination of the former and latter approaches; it features instead of a flat disk, a leading element with helical grooving which screws onto the end of the spring thus immobilizing the coils which enter it, while compressing the remaining active part of the spring. Once again this design suffers from the same list of shortcomings, limitations and deficiencies, as it is based on the same deficient concepts.

There is nothing in the prior art related to the spring having the capability of acting as an Actuator. In light of the foregoing we conclude that the prior art and its underlying concepts are clearly inadequate.

### 3. OBJECTS AND ADVANTAGES

One object of the present invention is to provide a spring with the ability of the dynamic adjustment, possibly according to a predetermined mathematical function or formula, of the spring Rate and therefore of the said spring stiffness by the control system depending on the operating conditions or requirements.

Another object is to be able to change the spring Rate and therefore its stiffness nearly instantly by the control system command or by a person either manually or remotely by means of an operator command.

Another object is to provide the spring the ability to change its stiffness and optionally its length with the required frequency and phase in order to be able to neutralize or mitigate the effects of a vibration affecting the spring and the load that it bears.

Another object is to provide a spring with the ability to change its stiffness and to suppress its oscillations after an impact.

Another object is to provide the spring with the ability to expand or contract lengthwise in conjunction with it varying its stiffness thereby providing it with the actuation capability.

### 4. BRIEF DESCRIPTION OF THE DRAWINGS

FIG. 1 shows side view of coil of hollow tubing helical spring with the helical spring-shaped smart memory alloy insert inside said tubing for varying said spring's coil diameter.

FIG. 2 is a side view of portion of hollow tubing helical spring wherein the inner and outer surfaces of said tubing have depressions of shapes designed to produce the lengthening of the outer surface and shortening of the inner surface when pressure is applied thereby causing the spring coils to contract radially.

FIG. 3 shows a spring coil part with a corrugated core bellows actuator-type inside of stripwound shell both of which are extendable lengthwise when pressure is increased inside.

FIG. 3A shows the optional shell type for the spring shown in FIG. 3

FIG. 4 is a view of the spring's section of twisted elliptical tubing whose cross-section is designed to turn when subjected to the inside pressure change.

FIG. 5 is a view of a portion of hollow tubing spring with practically non-expandable within operating pressure range lining, to limit the pressure acting on the tubing walls.

FIG. 6 is a view of a portion of hollow tubing spring with interconnected plugs at both ends of tubing to neutralize the longitudinal tensile stress while allowing the coils to expand their diameter under pressure.

FIG. 6A shows the cross-section of spring tubing of FIG. 6 where the end plugs are connected by roller chain.

FIG. 6B shows the cross-section of spring tubing of FIG. 6 where the end plugs are connected by corrugated strip with miniature balls.

FIG. 7 shows a side view of solid wire helical spring wherein miniature actuator is pressing upon its end tangentially to produce longitudinal compressive stress and coil diameter increase.

FIG. 8 shows a portion of hollow tubing spring with a variable inside volume and dynamically adjustable choke to control the fluid flow in and out of the spring.

FIG. 9 shows a portion of hollow tubing spring with a flexible link comprising contractible Smart Memory Alloy element and an extendable elastic element.

FIG. 10 shows centering bases for a spring undergoing coil diameter changes.

FIG. 11 shows cross-section of tubing of a spring with turnable SMA insert inside the tubing.

FIG. 12a shows housing plate of a leaf spring with inflatable hoses in it

FIG. 12b shows housing plate with rounded connectors's cross-section of a leaf spring.

FIG. 12c shows cross-section of a housing plate with shape varying elastic elements.

FIG. 13 shows the elastic element for curved leaf spring.

FIGS. 14 to 16 show shape varying cross-sections of spring tubing

FIG. 17 shows the hollow tubing spring with partly screwed in inside solid wire spring

FIGS. 18 to 18b show cross-sections of spiral spring tubing.

### 5. DESCRIPTION OF PREFERRED EMBODIMENTS

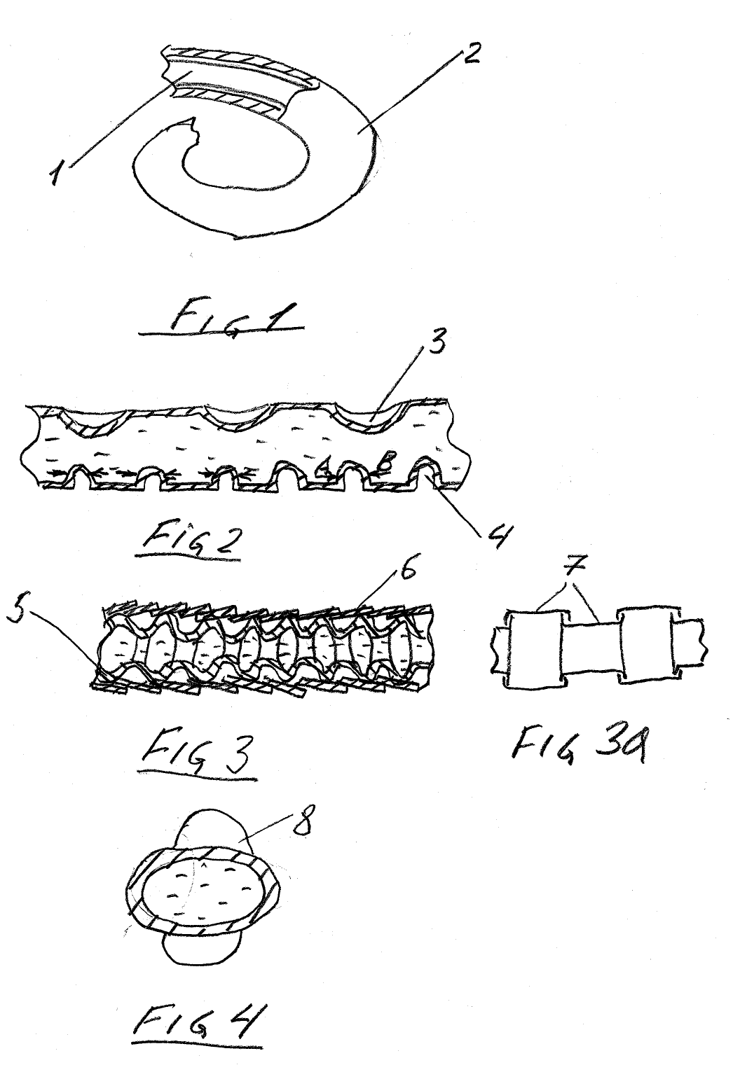

First embodiment of the present invention is suitable for a number of spring types. The helical spring (FIG. 1) can be implemented by using not the solid metal or other solid elastic material coiled wire, but of hollow coiled tubing made of the same or similar materials as the known springs that they are intended to replace. In the hollow tubing (2) is placed a smart memory alloy (hereinafter SMA) insert (1) itself having the appearance of a coiled spring with the same number and diameter on centerline of coils as the helical tubing. Insert (1) can be inserted by means of screwing it into the coiled hollow tubing of the spring of this embodiment or by inserting a SMA wire into the tubing which is subsequently coiled forming a helical spring-like insert inside of the thus coiled spring of this embodiment. Said SMA insert may have grooves for the electric heating elements or the passage of coolant or heated liquid. Alternatively said insert can be itself in the form of tubing with the internal hollow large enough for the electric heating element and/or passage of coolant or heated liquid. A separate grooving on said SMA insert can be provided for the purpose of cooling the SMA insert or a clearance between the said insert and the inner surface of the spring's tubing or the internal hollow of said insert can be used for the cooling purposes. A different version of this embodiment will comprise a solid wire coiled spring with a helical SMA element having corresponding coil diameter and the same number of coils attached to said spring's solid wire by means of brackets or clamps etc along said solid wire's length. Optionally these 2 versions can be implemented using not a single SMA insert or single external SMA element, but a plurality of such inserts or external elements placed respectively into or onto individual spring coils.

The second embodiment of this invention will comprise hollow tubing helical spring (FIG. 2) wherein the inner and outer surfaces of said tubing have respectively indentations and depressions on its surface. Said depressions of predetermined cross-sectional shape and outline shape are designed to produce the lengthening of the outer surface therefore said depressions (3) may be curved in two directions; both lengthwise and across the tubing to provide the necessary slack for said depression straightening out, preferably gradually. Said gradual straightening out would be determined by the shape of its curving, with shallow edges straightening out first and so on—wherein the deepest part of the depression may be designed to never straighten out within normal inside pressure range. However selecting a configuration of depressions for abrupt straightening out when under the inside pressure—popping of these depressions is an option which would produce a spring switchable between 2 possible states of such spring. Said indentations (4) on the inner surface of the tubing are curved in only one direction and thus have no slack as they are not designed to ever straighten out, but to narrow under pressure thereby shortening the inner surface of the tubing when pressure is applied. The filling of the tubing will either be electro-active polymer (hereinafter EAP) able to controllably change its volume/size when the voltage is applied and/or hydraulic fluid/oil pressured by either a suitable membrane/piston or a pump in known ways as described in our patent application PCT/IL15/00021. There may be a combination of an EAP insert into the hollow tubing while the rest of it is filled with hydraulic oil/fluid. Alternatively the filling can be a material having a high thermal expansion coefficient such as for example wax—in the latter case a suitable electric spiral runs through the length of the tubing. Optionally the required pressure inside the tubing can be created via a connection to pneumatic system providing pressurized air at predetermined pressure. There is also an option of using a solid wire helical spring-like insert with the same number and diameter (on wire center) of coils for bolstering the hollow tubing of this embodiment's resistance to shear stress produced by loading of the spring of present embodiment, similarly to the way it is described for the fourth embodiment. This embodiment is to work for the rather thin tubing walls along the whole cross-section perimeter or for the otherwise thicker tubing's cross-sections having thinner-walled areas extending along the tubing length, where said depressions and indentations are located; usually the wall thickness in depression areas in both cases will be less than 1.0 mm.

The spring of the third embodiment (FIG. 3) has a corrugated core (5), implemented much like in a bellows actuator. However as the corrugated structure of the bellows actuator-type expandable element cannot take significant shear stress, present in the springs due to their operating load, it is be enclosed inside of stripwound shell (6) both of which are extendable lengthwise when pressure is increased inside. Said stripwound shell can be implemented as a cylindrical spiral where all the coils partially overlap each other or (FIG. 3a) it can be comprised of two intertwined cylindrical spiral strips (7) with perpendicular to the strip surface edges, which when extended will limit the amount of any such extension as said perpendicular edges will come into contact pressing against each other. To prevent the abrasion of said corrugated core, suitable lining (not shown) can be placed around the corrugated core and lubrication can be applied. The pressure inside inner corrugated core's hollow can be created by appropriate means among the means for that described for the second or for the fourth embodiments. Concave and convex centering base pair (FIG. 10) can be used for this and other embodiments with significant coil radius change.

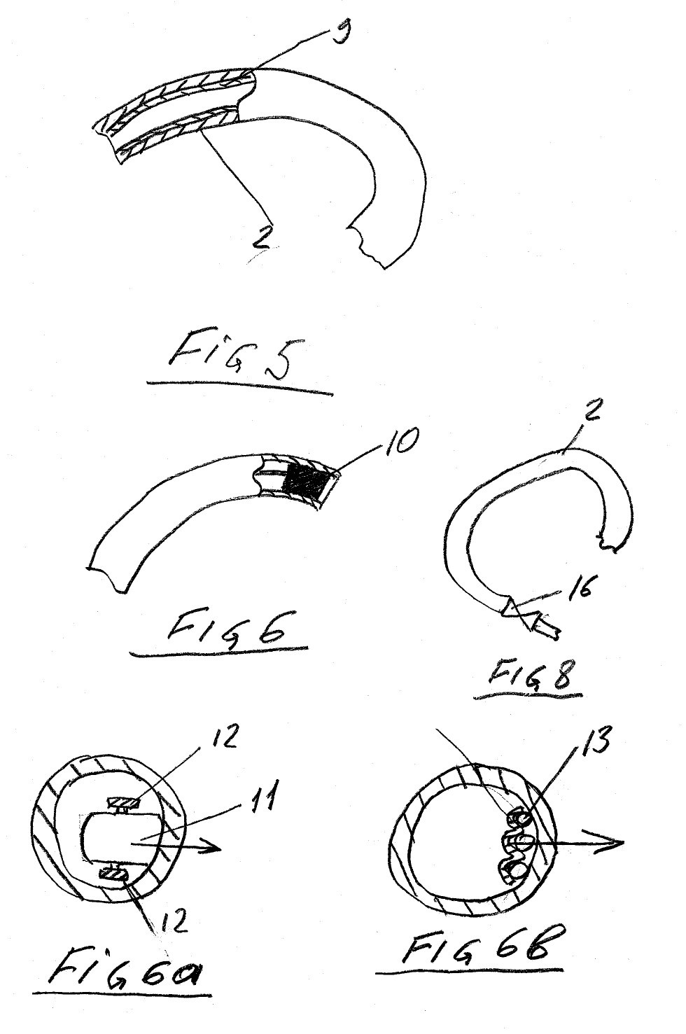

The spring of the fourth embodiment (FIG. 4) is also made of hollow tubing that has a symmetrical and elongated cross-section such as for example an ellipse or an oval, but the tubing will be twisted relative to the tubing's axis. Said twisting will be helical, can be directed either clockwise or counter-clockwise and the extremities of elliptical cross-sections will form ridges (8) that appear like large rounded cross-section thread with generally high to very high pitch angle. The filling of the tubing will either be EAP able to controllably change its volume/size when the voltage is applied or an EAP insert in combination with oil/hydraulic fluid filling or hydraulic fluid/oil pressured by either a suitable diaphragm/piston or a pump. Alternatively the filling can be a material having a high thermal expansion coefficient such as for example wax—in the latter case an extendable electric spiral runs through the length of the tubing. Optionally the required pressure inside the tubing can be created via a connection to pneumatic system providing pressurized air at predetermined pressure. The springs of this embodiment can be provided (previously described in our provisional application 62/250717) with a stripwound spiral insert or solid helical spring-like insert of a round or other suitable cross-section (not shown), with the same number and diameter (on center) of coils as the tubing spring into which it is inserted through the entire length of the tubing and consisting of suitable material, such as for example spring steel—said insert's purpose is to strengthen the hollow tubing spring's resistance to shear stress acting across the tubing that is resulting from spring loading.

The fifth embodiment is a tubing spring feature which is suitable for use in the coiled tubing springs, tubing torsions or variable stiffness tubing rods in the housing plate of leaf springs. Said springs comprise hollow tubing with generally round tubing cross-section (FIG. 5) with non-permeable for the liquid filling, practically non-expandable within the operating pressure range tubing's lining (9) to limit the inside pressure acting on the tubing walls and which allows much higher operating pressures inside. As the loop stress in the cylindrical tubing walls is known to be generally twice as high as the longitudinal tensile stress it is the major limiting factor for operating under higher inside pressure—greatly reducing the pressure on the tubing walls by using said lining will largely remove that limiting factor. The afore-mentioned lining can comprise carbon fiber, graphene, kevlar and other suitable materials and said lining needs to be glued or otherwise affixed to the tubing walls at its ends to prevent the oil/fluid penetration under it. The inside pressure in the springs tubing can be produced by the same or similar means as described above for the fourth embodiment.

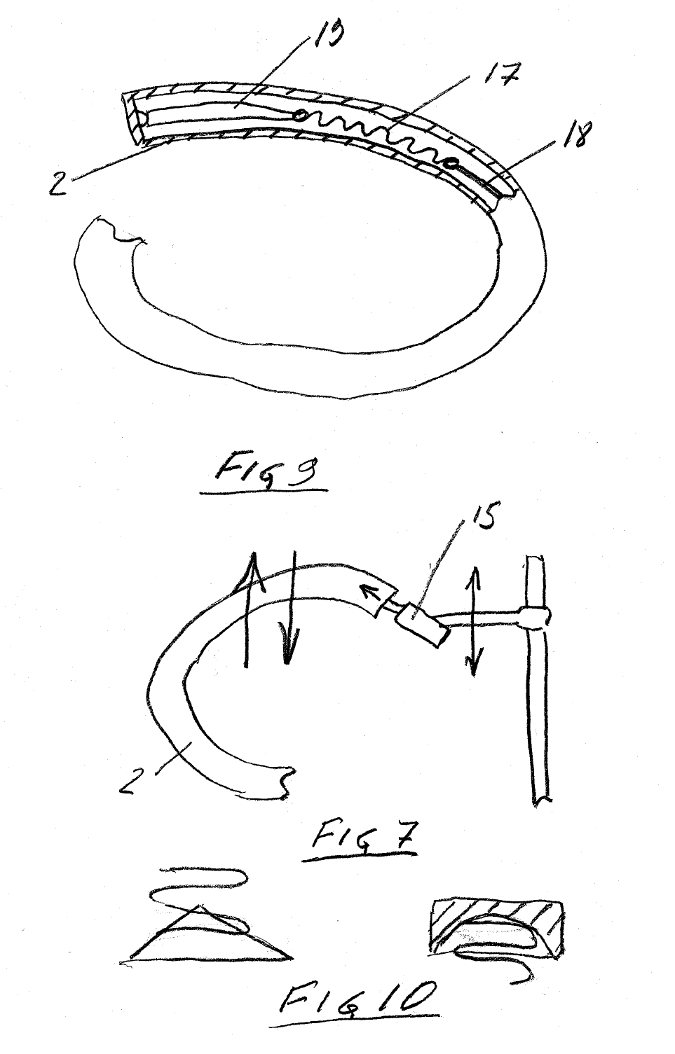

The spring of the sixth embodiment of the present invention (FIG. 6) is a hollow tubing spring with two plugs (10) at both ends of tubing, hermetically closing said ends, linked to each other by a taut string, strip or suitable roller chain running through the hollow of the spring. This arrangement allows avoiding the imposition of the longitudinal tensile stress on the tubing as the plugs are not held in place by means of attachment to the tubing's walls but instead by a string, roller chain or strip connecting both plugs thereby the pressure acting on both of the plugs is cancelled out. The plugs optionally can still be attached to the tubing's walls such as by a threaded connection for reliably and hermetically closing the spring ends, but the flexible link between them has to be sufficiently taut and of appropriate tensile strength to assure that the hydrostatic pressure on the end plugs is predominantly countered by the pull of said flexible link. Additionally friction for the flexible link inside the tubing needs to be reduced as much as possible by means of using low friction coating inside and/or lubrication when strings or wires are used. Alternatively roller chains of known varieties can be used with suitable roller diameter, length and shape preferably matching that of the inner hollow of the spring's tubing (FIG. 6a). Said rollers (11) between links (12) would preferably be as close to each other in the chain as practically possible to increase their number per unit of chain length thereby reducing the contact stress upon the tubing's wall. Another possibility is of using a flexible strip with corrugation along its width (FIG. 6b) wherein balls (13) are placed preferably filling them lengthwise. Said corrugation grooves (14) can be continuous along the entire strip length or interrupted. As the longitudinal tensile stress is thus largely eliminated, when the coils expand their diameter under internal pressure, the effect of decreasing spring stiffness is not diminished by said longitudinal tensile stress. The pressure inside can be provided by suitable means among those listed for the fourth embodiment.

The seventh embodiment of the present invention (FIG. 7) can be either solid wire helical spring or hollow tubing helical spring wherein a miniature (where appropriate) linear actuator (15) is pressing upon both free spring ends respectively in opposite directions, either directly or by an arm, tangentially to the coil ends to produce longitudinal compressive stress in the wire or tubing comprising said spring, and coil diameter increase; both of which are conducive to spring stiffness decrease. The arms could for example be mounted on the telescoping, to accommodate spring's changes in length, shaft(s), with said shaft(s) turned accordingly by a turn actuator. This embodiment can be used in conjunction with springs of other embodiments designed to produce stiffness decrease to produce greater combined effect.

The eighth embodiment (FIG. 8) is a hollow tubing spring with a variable inside volume and dynamically adjustable choke valve or other suitable types of known dynamically adjustable valves (16) to control the fluid flow in and out of the spring. Said volume changeability can be accomplished by using hollow tubing springs with various elongated cross-sections such as rectangular, elliptic, trapeze etc which when subjected to torsional deformation present in the coiled spring under load will experience cross-sectional profile distortion and cross-section area change along the whole length of spring's tubing resulting in its volume change and accordingly oil/fluid flow in or out of the spring. Alternatively the tubing's cross-sectional profiles described in our patent application PCT/IL15/00021 can be used to produce spring's inner hollow volume changeability.

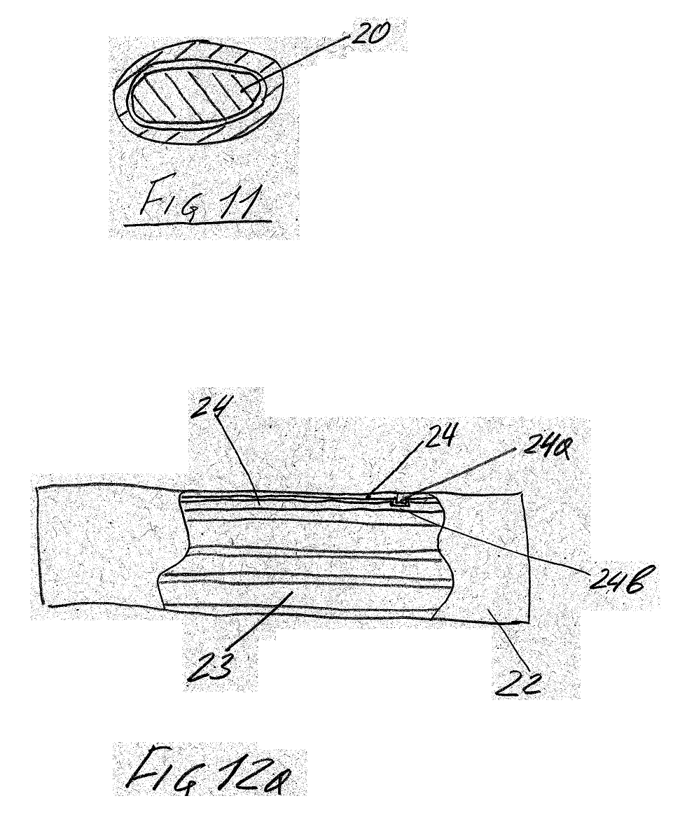

The ninth embodiment of the present invention will comprise (FIG. 9) hollow tubing with a flexible link (18), comprising a suitable contractible element(s) (17), with said link (18) extending through the whole length of tubing's hollow and attached to both ends of said tubing. Flexible link (18) may include strings(s) or wires (11) attached to said contractible element(s) and possibly to one of the ends of tubing. Said contractible element could be a string/strand of graphene fibers which will contract once the voltage is applied, a strand of suitable EAP which will contract when the voltage is applied or an SMA spiral element which will contract when activated. However as the length of tubing wherein the contractible element(s) is/are located won't significantly change, therefore if the contractible element(s) change of length is significant, extendable elastic element(s) (19), consisting for example of elastomer wire, need to be comprised in the flexible link (18) to assure that by extending a predetermined distance when the contractible element(s) (17) contract by that distance, the length of the flexible link (18) is kept generally constant while significant pressure is acting on the coils compressing them radially from the inside. Otherwise if the flexible link (18) shortens by a significant amount while the tubing doesn't, the spring can be damaged or disfigured. Thus the element(s) (17) contraction will produce large pressure on the inner side of the tubing's inside thereby causing the coil radius decrease which will lead to springs stiffening. As the contractible element(s) contract, while the extendable elastic elements extend, this will involve said elements movements inside the hollow tubing which need to be made with minimal friction. Such friction minimization for the flexible link can be provided by means described for the sixth embodiment.

The tenth embodiment (FIG. 10A) of the present invention will feature a coiled spring either made of solid wire or of hollow tubing with an electric heating element mounted on the solid wire or hollow tubing of the spring or inside the tubing for the hollow tubing spring. There may be also thermal insulation mounted on the whole spring or on its solid wire or tubing to reduce the electricity consumption to keep it heated to the required temperature to accomplish its modulus of elasticity and thus stiffness reduction. This way of stiffness reduction would be especially effective for the plastic springs.

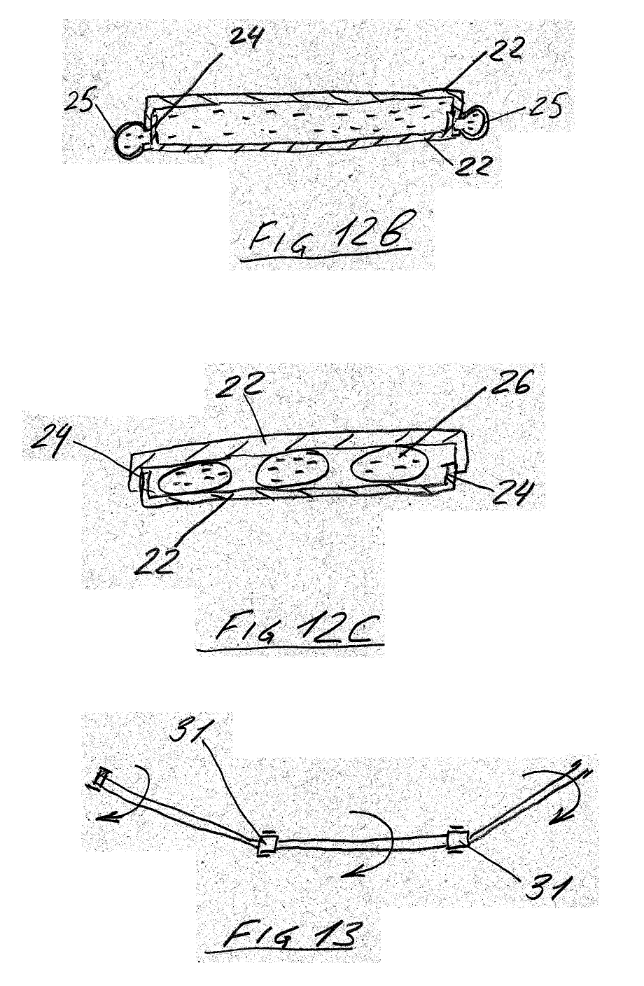

The eleventh embodiment of the present invention (FIG. 11) will comprise hollow tubing wherein is inserted an SMA element along its length. The tubing may have an elongated cross-section such as elliptic, oval etc and the SMA insert (20) will have a cross-section shape suitable for being snugly inserted into the tubing such as respectively a slightly smaller ellipse, oval etc. If a generally round cross-section is used it will need to have ridges or grooves on its inner wall, likely produced during its extrusion (FIG. 11a) for the SMA insert to exert force upon. The SMA insert may also feature grooves for the passage of heated liquid or coolant if they are used, but generally the electric heating element is expected to be used. The end of the SMA insert (20) will need to be installed in a manner assuring that it is immobilized, while the rest of it will be able, when activated, to turn its cross-section at a predetermined number of degrees per unit of length and thus also turn the surrounding it tubing. The spring types for which this embodiment is most suitable to be implemented are torsions or helical springs. A different version of this spring (FIG. 12) will feature a solid wire of elongated cross-section such as a rectangle and may be produced as a cut spring. To it will be attached an SMA element (21) of matching shape, such as a cylindrical spiral with the same number of coils and same coil diameter on centerline in case of a helical spring, by suitable known fastening means such as clamps, brackets, suitable wrapping (21a) etc enclosing both the solid wire and the pressed against it generally flat side of SMA element (21) placed along the length of said solid wire.

The twelfth embodiment (FIG. 12a) will feature a leaf spring comprised of at least one housing plate comprising two component plates (22); between which are located along the length of the component plates (22) inflatable pieces of hoses (23) suitable for withstanding the operating pressures and expanding when subjected to them, such as for example the types of hoses similar to those used in peristaltic pumps. The lips (24) are for keeping the component plates aligned with each other and prevention of dirt and foreign objects getting into the space between the component plates and will preferably be lubricated along their contact surfaces. The lips (24) will preferably feature ribs (24a) and matching channels or grooves (24b) on the opposite component plate for prevention of misalignment of buckling of the component plates to assure that they bear load as one integrated structure comprising the housing plate. This kind of ribs and channels or other known suitable means to prevent misalignment and buckling are desirable to be used in other versions of this embodiment where the lips are present. The ends of the component plates can be held together by means of a bracket, bolted together or welded together, but in the latter case such housing plate will generally not be openable for repairs. Said pieces of hoses will be either connected to a hydraulic system comprising a hydraulic pump which would provide fluid input at predetermined pressure level and output for them. Alternatively said input could be generated by the actuated diaphragm or piston unit or by other means such as listed for the fourth embodiment. For controlling differentially the flexural stiffness along the length of the leaf spring; the housing plate(s) could be divided into sections with groups of said pieces of hoses located in these sections. Said pieces of hoses' lengths will be commensurate with that of their sections A second version of this embodiment will have (FIG. 12b) 2 component plates (22) with hydraulic fluid between them, preferably also having lips (24), but also the flexible rounded connectors (25) connecting the two component plates along their length, having a rounded cross-sectional shape known to allow distance variability between its end points while relatively uniformly distributing the stress along its cross-section's length and thus avoiding permanent deformation while said distance variability is within a pre-determined range. It is also possible to implement this version of the twelfth embodiment without the use of rounded connectors by means of using the gaskets between the lips (24). This version will have the same sources of high-pressure input as the first version or as described for the fourth embodiment. The third version of this embodiment (FIG. 12c) works by changing the elastic elements' cross-section's area moment of inertia thereby changing the elastic elements stiffness. It will comprise a hollow tubing pieces (26) of a rounded moderately elongated cross-section such as for example elliptical which is well suited for transforming into a close to circular shape with stress in its walls staying within the limits of elastic deformation, with the increase in inside pressure by means such as those listed for the fourth embodiment. The ends of said elastic elements can be covered by suitably strong, flexible and/or elastic caps (27) held in place by known means which may include glue and screw-tightenable flexible brackets (28) mounted over the skirting (27a) of said caps. There is also an option of these elements having tapered rounded ends which are welded or otherwise closed shut. Said elastic elements can be assembled inside a housing plate similarly to the previous versions of this embodiment. Alternatively said elements of different lengths or of the same length can be assembled into packs and held together by suitable brackets mounted at their ends while having the attachment points on said brackets and load application point implemented largely as it is for a conventional leaf spring. Possibly a group of single such elastic elements can be used in certain applications or one single element. If said elliptical profile's major axis was positioned vertically then with the increase in inside pressure its transitioning to circular or nearly circular cross-sectional shape will decrease its major axis length and accordingly will also decrease its area's moment of inertia relative to its horizontal central axis. If said elliptical profile's major axis was positioned horizontally then with the increase in inside pressure its transitioning to circular or nearly circular cross-sectional shape will decrease said major axis by a predetermined amount while increasing its minor axis length by a predetermined amount and thereby increase its area's moment of inertia relative to its horizontal central axis. The aforementioned area's moment of inertia changes corresponds to the flexural stiffness changes. The overall leaf spring stiffness change will also depend on the number of such shape changing elastic elements in a housing plate and a number of such housing plates in the leaf spring assembly. This embodiment can also be implemented by using between the component plates (22) of SMA inserts, or EAP inserts/filling or other inserts using volume changing upon application of voltage materials (such as comprising vanadium dioxide) for effecting the distance change between said component plates.

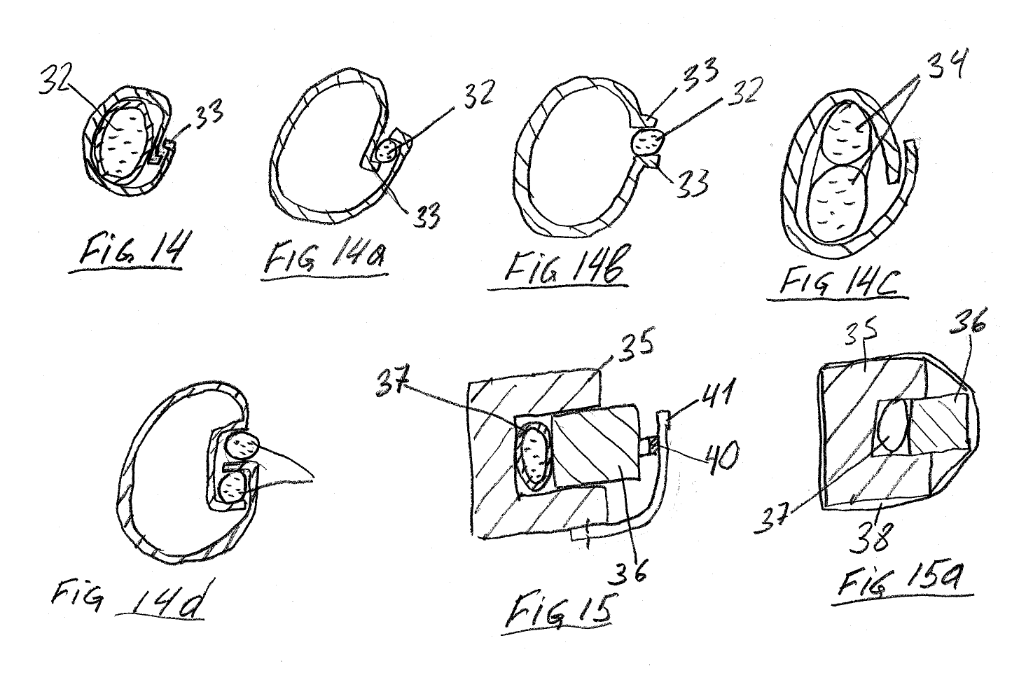

For the thirteenth embodiment (FIG. 13) the flexural stiffness variability will be accomplished by way of varying the area moments of inertia as in the twelfth embodiment however it will be done by means of turning the elastic beam(s) with elongated cross-sectional profile such as elliptic or oval. Said turning has already been described in patent application PCT/IL15/00021, but as it featured straight or nearly straight turnable elastic beams extending along the whole length of the housing plate such beams cannot be used in a significantly arched or curved leaf spring. Accordingly for the present embodiment the elastic beam will be divided into sections placed into holding cylinders (not shown, please refer to above mentioned PCT application, 1^{st} embodiment) of section matching length wherein they are supported by disks (not shown, same as above), segments etc and connected by suitable joints (30) such as a universal joint or a constant velocity joint. Alternatively the sections of the elastic beam can be joined by a flexible shaft connectors (31) of a suitable known flexible shaft type. Such turnable elastic elements may be used in leaf springs where there generally will be a plurality of them installed in parallel to each other along the length of the housing plate. It is desirable to re-inforce the housing plate in places along its length where the joints or flexible shaft connectors are. In second version of this embodiment such elastic elements supported by disks, segments etc in their individual holding cylinders as has been shown in the above referenced PCT application can be installed either singly or in groups, but without the housing plate such as by being embedded under furniture seating surfaces.

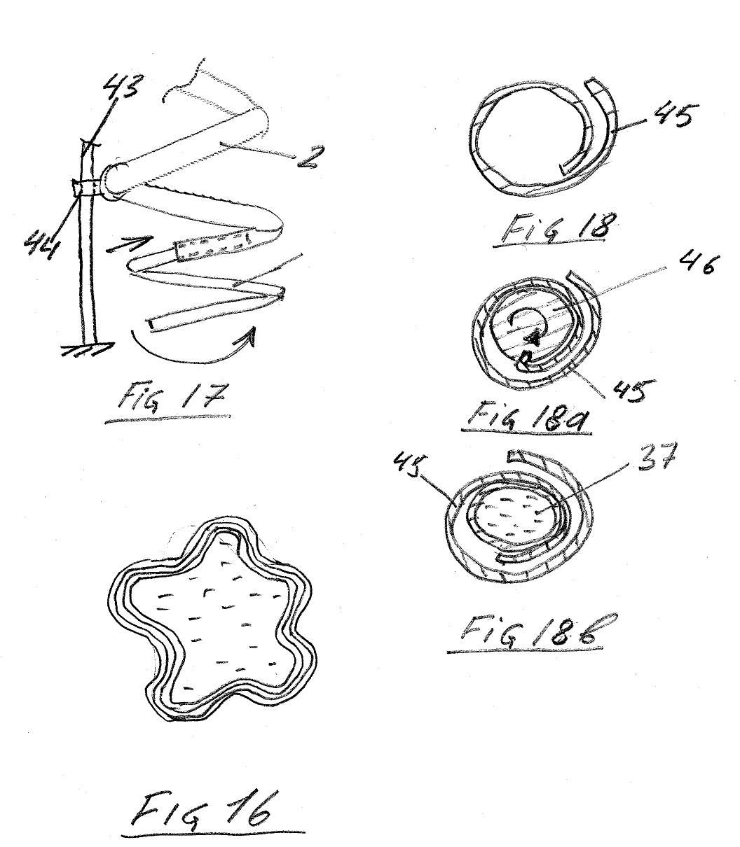

The fourteenth embodiment will feature the cross-sectionally expandable hollow tubing for the coil springs, turn springs, torsions and elastic elements in leaf springs. First version (FIG. 14) of said expandable tubing will have an openable rounded cross-section wherein is placed a cross-sectionally expandable hose (32) which is provided with high pressure fluid or air input which may come from sources described for the fourth embodiment. The edges (33) of said tubing's cross-section (FIGS. 14a, 14b, 14 c) can be made overlapping and slidably pressing against each other so as to insulate the inside of the tubing. Alternatively (FIG. 14c) two expandable hoses (34) wrapped or encased in an elastic material can be used for producing an elongated cross-section for applying a force on tubing's cross-section opposite sides. FIG. 14d shows a practically closed profile allowing its size expansion or contraction by means of differently varying the degree of expansion of 2 hoses moving one edge relatively to the other and keeping it rigidly in that position if necessary. The second version of this embodiment (FIGS. 15 and 15a) will have a cross-section comprised of a larger female profile (35) and a smaller profile (36) slidably inserted into it thereby forming a compound tube. For effecting the outward movement of said smaller profile (36), the inflatable and expandable hose (37) is placed between them. The elastic wrapping or elastomer encasement (38) encompasses the entire cross-section along the length of the compound tubing. Alternatively second expandable hose (39) or a wavy spring form (40), mounted on supports (41) and extending along the length of the compound tubing, can be provided for the inward movement of said smaller profile (36) or the arrangements for the reciprocal movement of smaller profile (36) similar to that with 2 hoses as shown on FIG. 14d can be used. The third version (FIG. 16) will feature the compound hollow tubing wherein the tubing walls are multi-layer and curved along the cross-sections perimeter to allow for the profile's radial expansion and each layer is very thin—generally significantly thinner than 1 mm. These kinds of tubing walls will allow significant tubing radial expansion which is conducive to increased torsional and/or flexural stiffness and accordingly the stiffness of the spring comprising it.

The fifteenth embodiment (FIG. 17) will feature hollow tubing coil spring into which is screwed by variable (depending on the stiffness and spring length/height required) number of coils a reinforcing cylindrical spiral preferably made of solid wire with the same coil diameter on center and of wire size and shape suitable for insertion into said hollow tubing. Either the hollow tubing or the re-inforcement spiral will be rotatable relative to the other part and the rotatable part will have a rotational actuator operatively connected to it—turning for example the base (not shown) of the reinforcement spiral (42) and thereby the affixed to it said spiral (42). In this example the hollow tubing will be prevented from turning by known means such as for example guidance rod (43) with the follower ring (44) over it, but will freely move (such as deform lengthwise due to operating load) and due to the spring intended change of length/height. This design with the reinforcement spiral for example being unscrewed from the tubing can be used in automotive suspension for lifting the vehicle for off-road conditions while at the same time making its suspension softer/less stiff. The sixteenth embodiment will feature the spring's tubing with the spiral cross-section (45) as seen of FIG. 18 which when subjected to torsional deformation due to spring loading depending on direction of said deformation will either coil tighter and its cross-section size will diminish thereby decreasing stiffness or vice versa. Thus a design is provided wherein the spring's loading causes deformation and leads to change in stiffness commensurate with loading—this allows to provide a constant force string or other spring with non-linear change in reaction force when loaded. If a turnable SMA insert (46) is provided (FIG. 18A) then the cross-section's core can be twisted/untwisted controllably as was described for the eleventh embodiment and producing the just described changes in stiffness controllably and not due to spring loading. Alternatively an expandable hose (37) can also be used for expanding/contracting the core of the spiral cross-section thereby varying stiffness

### 6. SKETCHES AND DIAGRAMS

Provided separately.

### 7. OPERATION

In operation of the spring of first embodiment (FIG. 1) the SMA insert (1) when activated, depending on what's in its memory will either contract radially pressing on the spring coils from the inside and thus producing coils of a smaller diameter and greater length of the whole spring or it will expand radially pressing on the string coils from the inside and thus producing coils of a larger diameter and shorter overall length of the spring. In the former case the spring will be rendered stiffer, in the latter case its stiffness will be decreased. As SMA elements allow positional control of their movement, the degree of the spring's coil contraction plus lengthening or coil expansion plus shortening and accordingly stiffness increase or decrease will be controllable. The springs of the second embodiment will either expand coils radially or contract them radially depending on where the expanding or contracting sides of their hollow tubing are and of course if the coils' diameter is narrowed stiffness is increased whereas if said diameter is increased stiffness in decreased. If the side with depressions (3) is facing outward that means the expanding side is outward—accordingly the contracting side with indentations is facing inward. When pressure is applied inside the hollow the depressions are to gradually straighten out and as the slack in them is straightened out that side of the tubing will expand. Meanwhile on the indentations (4) side the facets A and B of them facing each other lengthwise will be pushed by inside pressure towards each other narrowing the indentations and the side of tubing where they are located.

For the third embodiment (FIG. 3) the corrugated core (5) will expand lengthwise when the internal pressure rises inside of its hollow and will also exert a pull on the external stripwound shell (6) thus increasing this composite tubing's length and by extension increasing the spring coils diameter. Spring coil diameter is a major factor determining the stiffness of a spring and with its increase the stiffness will very substantially decrease. The expected large increase in the length of tubing and therefore a comparable increase in the diameter of coils of this embodiment can be justifiably expected to cause spring's stiffness variability by several times. The concave conical or semi-sphere etc centering bases (FIG. 10) on one end of these springs in combination with convex conical, semi-sphere etc centering base on the other end of the spring will keep these springs centered while their diameter changes. The combination of convex and concave bases will assure that springs vertical position, as shown by the position of the upper base is not changed solely due to its coils' diameter changes, but this is not related to the spring length itself changing when its coil diameter changes, which will change the position of said upper base.

For the springs of fourth embodiment (FIG. 4) when subjected to the increase in inside pressure the twisted tubing will begin to turn in the direction opposite to the direction of its twist in effect doing the untwisting motion. When that turning movement is coinciding with the direction of the torsional deformation resulting from the spring's loading then said torsional deformation will be promoted and the spring's stiffness will decrease. When it is in the opposite direction to the torsional deformation resulting from the spring's loading then the spring will be dynamically stiffened. It is also possible to pre-set the spring before loading and/or for an extended period of time by implementing said turning motion. Furthermore such turning motion of the cross-sections along the entire length of the spring will cause its length to change significantly thereby providing the actuation capability for such springs.

For the springs of the fifth embodiment (FIG. 5), the practically non-expandable within the operating pressure range lining allows the spring to operate at much higher pressure levels in effect reinforcing it without adding significant weight and thus being able to produce much higher stiffness increasing levels of longitudinal tensile stress. However these springs will still be subject to coil radial expansion making them less stiff and defeating the purpose of much higher operating pressure inside the tubing, thus necessitating the use of a retaining cylinder inside of which the spring will operate—that has been described in the above referenced PCT application PCT/IL15/00021.

The operation of the springs of sixth embodiment is adequately described in the description section and will not be reiterated here but is included herein by way of reference as if fully set forth.

The operation of the springs of seventh embodiment is adequately described in the description section and will not be reiterated here but is included herein by way of reference as if fully set forth.

The eighth embodiment (FIG. 8) will involve the deformation of the cross-section changing said cross-sections area. Said deformation of the cross-section, which occurs in the coiled springs and torsions, will be the more pronounced the greater is the radial distance from the cross-section's center as is more fully described in our PCT application PCT/IL15/00021. Accordingly the geometry of the cross-section subject to said deformation will become distorted and the cross-sectional area of the channels will change and thus the volumes inside said channels will also change, as will the overall volume of the tubing's inner hollow. The volume changeability due to the torsional deformation will also occur for the broad variety of tubing types with non-circular cross-sections such as oval, elliptic, rectangular etc and therefore those types of tubing may be suitable to be used in the springs of this embodiment. This changeability of volume will allow by means of varying the degree of choke (16) opening to regulate the flow in and out of the spring not only to counteract the deformation of the spring caused by its load thereby varying its stiffness, but may also be used for other purposes such as possibly counteracting the automotive suspension's (comprising the spring of present embodiment) vibrations and oscillations thereby eliminating or lessening the need for a shock absorber. Said volume variability leading to the inside volume/pressure variability can also be used for measuring the pressure and therefore the loading force causing said pressure to change. If the EAP filling has the piezo-electric quality and is inactive at the moment of such measurement it will generate a measurable voltage signal corresponding to the level of pressure. It should be noted that with large deformation (compression or extension) of the spring significant changes in the internal volume may be produced thereby possibly producing large pressure increases and then the means of mitigating such large pressure increases can be employed including the compressible liquid pockets or the compressible insert(s) or overflow vessels etc as was previously described in our pending application PCT/IL15/00021.

In the spring of the ninth embodiment (FIG. 9) the contractible element(s) (17) will initiate its contraction, the flexible link (18) will be hugging the inner sides of the coils inside the hollow and exerting pressure on them. That will cause the coils diameter to decrease which produces increased stiffness. Furthermore as the overall length of the tubing will not materially change the distance between the narrower coils will increase to accommodate largely the same length of the tubing thereby lengthening the spring and thus providing it with the actuation capability. The types of flexible links designed for minimizing friction such as corrugated strip with miniature balls in its corrugation grooves, roller chain etc will assure that friction does not impede the operation of the flexible link and therefore that of the spring of this embodiment.

The operation of the springs of tenth embodiment is adequately described in the description section and will not be reiterated here but is included herein by way of reference as if fully set forth.

The operation of the eleventh embodiment (FIG. 11) will have a degree of similarity with that of the fourth embodiment as the tubing's cross-section will be turned along tubing's whole length by the twisting of SMA insert inside of the tubing. If said turning coincides with the direction of torsional deformation due to spring loading the deformation will be promoted and thus the spring is dynamically rendered less stiff and vice versa when the direction of said turning is opposite to that of torsional deformation due to spring loading. It is also possible to pre-set the spring before loading and/or for an extended period of time by implementing said turning motion. Furthermore such turning motion of the cross-sections along the entire length of the spring will cause its length to change significantly thereby providing the actuation capability for such springs. When said turning shortens the spring the result is equivalent to pre-compressing the spring—it becomes shorter and stiffer. When said turning lengthens the spring, the spring is extended and only the SMA insert is keeping it in that state overcoming the force of the spring. The springs extension can be limited by a flexible link running through it such as string, chain, belt etc from a miniature (where appropriate) reel coupled with a suitable rotation actuator mounted together with the non-moving end of the spring. This design will allow the SMA insert to act on the spring with an extra force without changing its moveable end position beyond the required one and thus rendering the extended spring stiffer.

The reel with the flexible link controlling the degree of spring's expansion in order to provide higher stiffness in the expanded state, which can be controlled by the vehicle's etc control system, can be used in other embodiments having the actuation capability to expand the spring length.

For the twelfth embodiment the increase in pressure will lead to the radial expansion of pieces of hoses which will increase the distance between the component plates or for the second version of this embodiment, through the rising to predetermined level the pressure in the space between said component plates, the distance between said plates will increase. Likewise for the third version of this embodiment, the elastic elements (26) changing their cross-sectional shape due to increase in inside pressure, such as from elliptic to round, the distance between said plates (22) will also increase if said shape-changing elliptic elements were mounted with major axis parallel to the component plates. If said elliptic elements were mounted with major axis perpendicular to the plane of component plates then the pressure increase would produce a decrease of major axis length and the distance between the plates. Such increase in distance between the component plates and the increase in distance between ellipse extremities (when major axis is perpendicular to the elastic beam plane) will produce the area moments of inertia increase and accordingly the proportional to it flexural stiffness increase of the housing plate and vice versa.

The thirteenth embodiment (FIG. 13) works by providing connection to separate parts of compound elastic beam wherein the turn of said beam's first part that is operatively connected to the source of turning torque is transmitted at an angle to the direction of said beam's first part either by the suitable joints such as mentioned in the description universal joint or constant velocity joint or by a flexible part connector to the second part of said turnable beam. The turning of second part of the compound elastic beam in turn is transmitted to the third part by the same means. The elastic beam cross-section axis's angle to the horizontal plane in turn determines said beam flexural stiffness and accordingly the flexural stiffness of its curved housing plate and thereby the overall stiffness of the leaf spring.

The fourteenth embodiment has three versions. The first version has an open rounded shape (FIG. 14) which will have relatively low stiffness. When the hose (32) expands due to increase in pressure, it first presses the upper edge against the side of the lower edge creating a significant friction force. When said hose expands more the lip of the upper edge comes into contact with the lip of the lower edge and presses against it with a predetermined force which in effect makes the cross-section a much stiffer closed rounded shape as said force prevents the profile from opening again despite the clockwise torsional deformation taking place. The cross-sections presented on (FIG. 14a) and (FIG. 14b) will work the same way except using smaller diameter hoses differently located. On FIG. 15c the profile can be expanded by the two hoses packed together which would also make it more similar to a closed profile thus increasing stiffness. Profile (FIG. 14d) is in effect a closed profile but by differentially inflating the upper and lower hoses the lip of the lower edge can be made to move in either direction thereby making the rounded profile bigger and thus stiffer or smaller and thus less stiff. As the diameter of the springs wire is in the divisor of a known formula for spring stiffness in the fourth power, changes in the diameter or size of a rounded profile is likely a very effective way of controlling stiffness. The second version (FIG. 15) features the expanding hose (37) pushing outward the inserted smaller profile (36). As the overall cross-sectional profile thus expands increasing its polar moment of inertia (aka torsional constant), the torsional stiffness of said profile increases and so does the stiffness of the spring comprising said profile. The elastic wrapping or encasement will push the inserted profile back inward once the size of the hose (37) diminishes due to decreased pressure. The third version (FIG. 16) allows larger radial expansion of tubing compound profile without the irreversible plastic deformation taking place as the tubing walls are multi-layer and each layer is very thin—generally significantly thinner than 1 mm. Such thin layers can bend and move more without the irreversible deformation whereas them being in a plurality will allow the compound walls to take significant hydraulic pressure and other forces.

The operation of the springs of fifteenth embodiment is adequately described in the description section and will not be reiterated here but is included herein by way of reference as if fully set forth.

The operation of the springs of sixteenth embodiment is adequately described in the description section and will not be reiterated here but is included herein by way of reference as if fully set forth.

What claimed is:

1. A Spring comprising means for changing the geometry of said spring's elastic elements which results in change of its stiffness.

2. The Spring of claim 1 wherein said elastic element is helically coiled hollow tubing and said means for changing elements geometry are the means for varying said spring's coil radius.

3. The Spring of claim 1 wherein said means for changing elements geometry are the means for varying said springs elastic element's cross-sectional outline.

4. The Spring of claim 1 wherein said means for changing elements geometry are the means for twisting said spring's helically coiled structural member around its lengthwise axis along its length.

5. A Spring comprising means for varying the stress levels within said spring's helically coiled structural member

6. The Spring of claim 5 wherein said coiled structural member is liquid-filled hollow tubing with practically non-extendable within normal pressure operating range and non-permeable for said liquid lining.

7. The Spring of claim 5 wherein said coiled structural member is liquid-filled hollow tubing with interconnected by flexible linkage plugs hermetically closing the ends of said tubing.

8. The Spring of claim 5 wherein said coiled structural member is subjected to tangentially directed and equal force, provided by actuator means and acting in opposite directions on its ends.

9. The Spring of claim 2 where said means for varying coil radius comprise a flexible link inside the hollow tubing comprising at least one contractible part.

10. The Spring of claim 2 where said means for varying coil radius comprise a smart memory alloy spring-like insert inside the coiled hollow tubing with said insert by changing its radius controllably forcing the tubing's radius to change thereby changing stiffness.

11. The Spring of claim 3 made of hollow tubing of a shape changing its volume when spring load is applied thereby also changing the pressure inside the tubing causing the fluid flow through its open end which is changeable by adjustable valve means thereby changing the spring's stiffness.

12. The spring of claim 10 made of hollow tubing which contains inside its tubing's hollow a flexible link with at least one contractible element comprised within said flexible link which is attached to both ends of said tubing for the purpose of contracting when activated and thereby producing coils radial contraction which increases the spring's stiffness.

13. The Spring of claim 4 where said means for twisting the helically coiled structural member comprise a spring-like smart memory alloy element which is immobilized on one end and is assembled together with the helical coiling of the spring so as to be able to twist together with spring coiling thereby varying its length and stiffness.

14. The Spring of claim 3 where the means for changing cross-sectional outline comprise an expandable hose running along the length of the coiled structural member and said structural member having an open cross-section which is flexible by said expandable hose thereby varying the torsional constant of said coiled structural member and the spring's stiffness.
